(19) United States
(12) Patent Application Publication
(10) Pub. No.: US 2016/0187168 A1
(43) Pub. Date: Jun. 30, 2016

(54) Music Amplifier Knob and Pedal Marker

(71) Applicant: John L. Sullivan, Joliet, IL (US)

(72) Inventor: John L. Sullivan, Joliet, IL (US)

(21) Appl. No.: 14/881,156

(22) Filed: Oct. 13, 2015

Related U.S. Application Data
(60) Provisional application No. 62/066,095, filed on Oct. 20, 2014.

(51) Int. Cl. G01D 13/04

(52) U.S. Cl. CPC G01D 13/04

(57) ABSTRACT

A marker useful in recording a desired setting of an amplifier, of the type comprising a control panel having at least one control knob disposed thereon, is disclosed. The marker comprises a sheet of material having a first major surface securable along the control panel adjacent a portion of the control knob proximate an approximate desired setting of the control knob. A second major surface of the sheet of material opposite the first major surface is capable of receiving a mark thereon to further indicate a desired setting of the control knob.

### BACKGROUND OF THE INVENTION

1. Field of Invention

The present general inventive concept relates to audio amplification systems, and more specifically, to an apparatus useful in recording control settings on an audio amplification system, for example to allow for more convenient tuning of an audio amplification system to a desired setting or combination of settings.

2. Description of the Related Art

Audio amplification systems, such as for example electronic audio amplifiers, electronic audio pedal controls, etc., are sophisticated electronic devices, having a myriad of inputs, outputs and control features. In a stand-alone use, individual audio amplification systems may be associated with, for example, a single musical instrument, microphone, or the like. In a multi-piece use, a plurality of individual audio amplification systems may be provided for use in a band or other musical ensemble. In either case, the controls on an audio amplification system must be “tuned” to provide a desired overall audio effect. This “tuning” process must often be repeated each time an audio amplification system is set up for use. Typically, during set-up of an audio amplification system, general control settings are made based on experience. These settings may then be refined during a subsequent fine-tuning procedure. Depending upon the complexity of the audio amplification system, this can be a very time consuming and frustrating process.

In certain applications, speedy re-tuning or adjustment of an audio amplification system is necessary. For example, in certain applications, a first set of audio amplification system settings which are desirable for use in a first musical performance may be undesirable in second musical performance, in which a second set of audio amplification system settings is desirable. In a musical performance comprising a plurality of songs, for example, it may be desirable to quickly adjust the controls on one or more audio amplification systems employed in the performance in order to provide a different overall audio effect for each song. However, due to the need for fine-tuning, it is often difficult to quickly change the control settings of an audio amplification system to a desired setting.

In light of the above, a device which allows for recording control settings and related information on an audio amplification system, so as to substantially reduce the time associated with changing the control settings of the audio amplification system to a desired setting, is desired.

The features of the present general inventive concept will become more clearly understood from the following description of the invention read together with the drawings.

### SUMMARY OF INVENTION

The Music Amplifier Knob and Pedal Marker provides a way to mark settings by means of an adhesive label on an audio pedal, amplifier, or other device. The Marker offers the benefit of being able to quickly recall the desired positioning of the knobs, sliders, etc. by recording a mark on the label. It also offers the benefit of non-permanent adhesive to prevent residue build-up on a device, preserving its original condition upon removal of the Marker.

There is currently no known dedicated product that provides the benefits mentioned above. Therefore, this is not an improvement to an existing product; rather, it is a new solution for recording preferred position settings on various devices.

### BRIEF DESCRIPTION OF THE SEVERAL VIEWS OF THE DRAWING(S)

The following are brief descriptions of the Music Amplifier Knob and Pedal Marker drawing figures:

FIG. 1. Front and Side View of Music Amplifier Knob and Pedal Marker.

FIG. 2. Adhesive Layer of Marker Being Peeled from Backing.

FIG. 3. Audio Pedal Shown without Marker.

FIG. 4. Illustration of Marker Placement on Audio Pedal.

FIG. 5. Amplifier Shown without Marker.

FIG. 6. Illustration of Marker Placement on Amplifier.

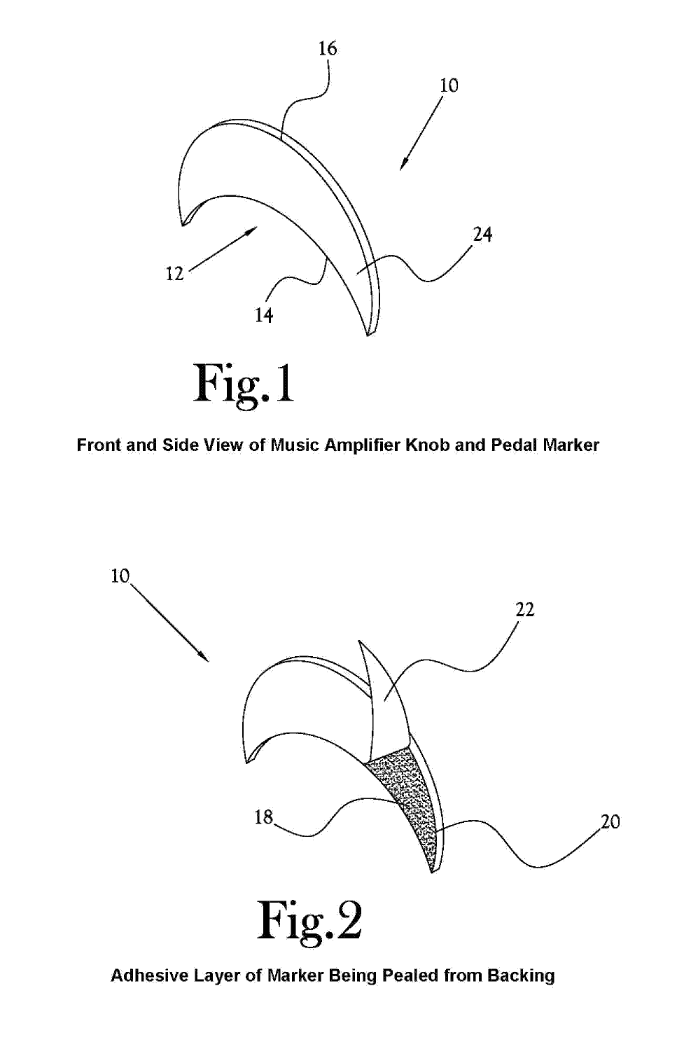

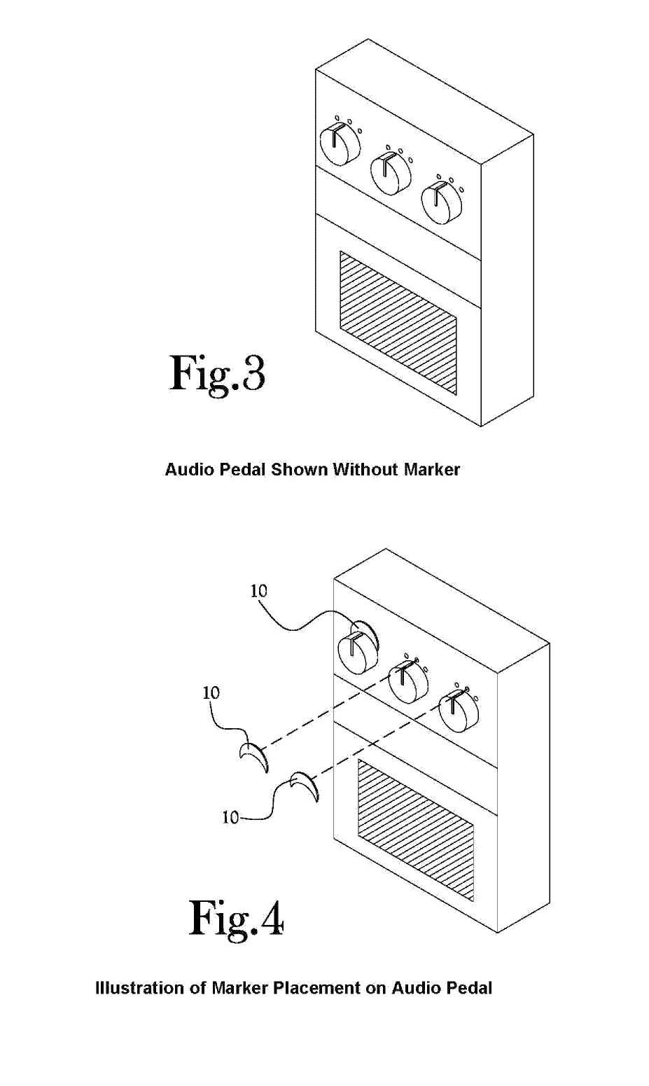

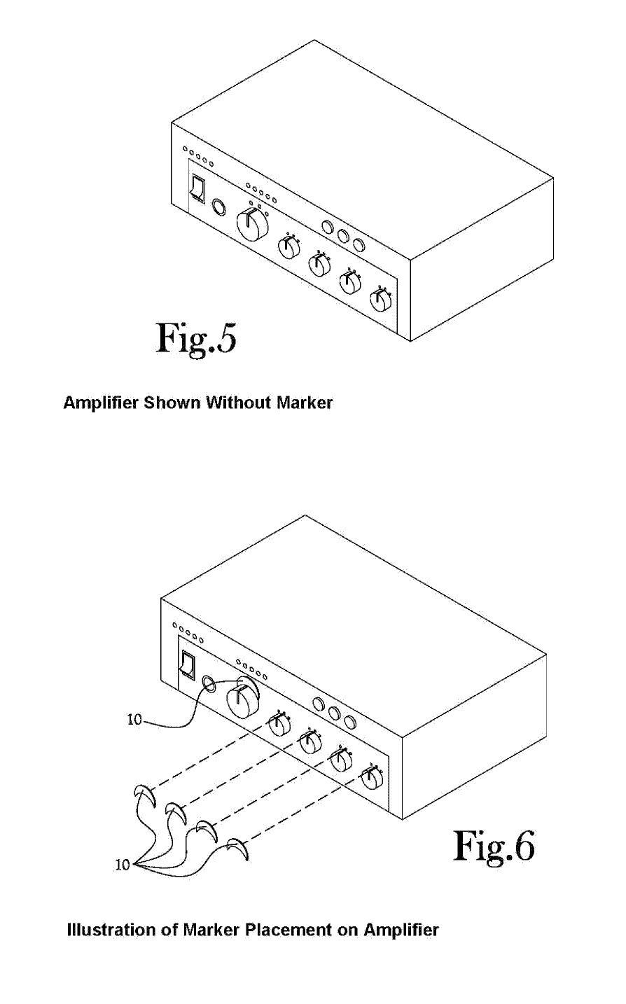

### DESCRIPTION OF THE INVENTION

Reference will now be made to certain example embodiments of the present general inventive concept, which are illustrated in the accompanying drawings and illustrations. The example embodiments are described herein in order to explain the present general inventive concept by referring to the figures. The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is inverted or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

According to various examples of the present general inventive concept, a music amplifier knob and pedal marker is provided which may allow a user to record control settings and related information on an audio amplification system, electronic audio pedal control, or other such device (hereinafter, collectively, “amplifier”), so as to substantially reduce the time associated with changing the control settings of the audio amplification system to a desired setting. One embodiment of a music amplifier knob and pedal marker, or “marker,” is identified as 10 herein and in the accompanying figures. With reference to the figures, the marker 10 comprises a substantially planar sheet of material 12 which is shaped to extend along a control panel of an amplifier adjacent to a portion of a control knob of the amplifier. For example, in the illustrated embodiment, the sheet of material 12 defines a crescent shape having an inner curved edge 14 and an outer curved edge 16. The inner curved edge 14 of the sheet of material 12 is shaped to accommodate a control knob of an amplifier, such that the inner curved edge 14 of the sheet of material 12 may extend along a portion of a perimeter edge of a control knob of an amplifier. In this configuration, the sheet of material 12 may be positioned along a control panel of an amplifier with the inner curved edge 14 extending along, or slightly beneath, a portion of a perimeter edge of a control knob of the amplifier, and with the outer curved edge 16 extending outwardly therefrom along the control panel.

In various embodiments, the sheet of material 12 is securable along the control panel of the amplifier. For example, in several embodiments, an adhesive layer 18 is provided along a first major surface 20 of the sheet of material 12, such that the first major surface 20 may be adhered to the control panel. In certain embodiments, a releasable backing 22 is provided along the adhesive layer 18 opposite the sheet of material 12 to allow for more convenient storage and packaging of the marker 10 prior to use. Those of skill in the art will recognize other suitable devices and materials which may be used to allow the sheet of material 12 to be securable along the control panel of the amplifier, and it will be recognized that such devices and materials may be used without departing from the spirit and scope of the present general inventive concept. For example, in various embodiments, a hook and loop fastener or other suitable fastener device may be provided to secure the sheet of material 12 along the control panel of the amplifier.

In the illustrated embodiment, the adhesive layer 18 is fabricated from a non-permanent, removable adhesive. Thus, in this embodiment, the first major surface 20 may be releasably adhered to the control panel, and subsequently removed from the control panel via peeling techniques of the type known in the art. In certain more discreet embodiments, the adhesive layer 18 is of a type of adhesive which maintains adhesive properties following initial securement to, and subsequent removal from, the control panel. Thus, after the first major surface 20 is releasably adhered to, and subsequently removed from, the control panel, the first major surface 20 may be re-adhered to the same control panel, for example in order to reposition or otherwise adjust the placement of the marker 10 along the control panel, or may be re-adhered to a different control panel. It will be recognized that the removable adhesive layer 18 may allow placement and removal of the marker 10 along the control panel without damaging, soiling, or otherwise marring the control panel.

According to several features of the present general inventive concept, in various embodiments, a second major surface 24 of the sheet of material 12 opposite the first major surface 20 is capable of being marked upon using a standard marking or writing tool of the type known to one of skill in the art. For example, in several embodiments, the sheet of material 12 is fabricated from a markable material, such as for example paper, plastic, or the like. Thus, upon positioning and securing the sheet of material 12 along a control panel of an amplifier with the inner curved edge 14 extending along, or slightly beneath, a portion of a perimeter edge of a control knob of the amplifier, the second major surface 24 may be marked with indicia indicating a desired setting of the control knob. In certain more discreet embodiments, the second major surface 24 is fabricated from an erasable surface, such that marks applied to the second major surface 24 may be erased. In several embodiments, the sheet of material 12 is fabricated from a glass or polymer material, or other suitable material, such that the second major surface 24 is a dry-erase surface, of the type which may receive a mark from a dry-erase marker of the type known in the art and may subsequently allow convenient erasure of the mark by wiping the mark away, absent the need for application of cleaners to the second major surface 24. In some embodiments, the second major surface 24 may define a color which allows more ready visibility of markings made thereon. For example, in certain embodiments, the second major surface 24 may define a white surface, a fluorescent surface, a luminescent surface, or other such color. In other embodiments, the sheet of material 12 is a transparent or translucent material.

In several embodiments, the marker 10 provides preexisting indicia thereon to indicate an approximate desired setting of a control knob of an amplifier. For example, in the illustrated embodiment, the radially thickest portion of the crescent-shaped sheet of material 12 may be used to indicate an approximate desired setting of a control knob of the amplifier. Thus, in one method of use of the marker 10, a control knob of the amplifier may be tuned to an approximate desired setting, and the sheet of material 12 may be positioned and secured along the control panel of an amplifier with the thickest portion of the crescent-shaped sheet of material 12 extending radially outwardly from the control knob of the amplifier adjacent the approximate desired setting of the control knob. Thereafter, the control knob may be fine-tuned to a desired setting, and one or more additional markings may be applied to the second major surface 24 of the sheet of material 12 to more accurately indicate the desired setting of the control knob.

Numerous other types of preexisting indicia will be recognized by one of skill in the art, and such other preexisting indicia may be used without departing from the spirit and scope of the present general inventive concept. For example, in other embodiments, the overall shape of the sheet of material 12 may define a radially-outwardly projecting corner, radially-inwardly projecting dimple, or other such shape in order to better define the indication of the approximate desired setting of the control knob. In other embodiments, the second major surface 24 of the sheet of material 12 may include thereon one or more preexisting markings, such as for example lines, arrows, color gradients, or the like, to indicate the approximate desired setting of the control knob.

From the foregoing description, it will be recognized that a music amplifier knob and pedal marker is provided which may allow a user to record desired control settings and related information on an audio amplification system, audio pedal control, or the like, so as to substantially reduce the time associated with tuning the control settings of the audio amplification system to a desired setting. While the present invention has been illustrated by description of several embodiments and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. A marker useful in recording a desired setting of an amplifier comprising a control panel having at least one control knob disposed thereon, the marker comprising:
a sheet of material having a first major surface securable along the control panel adjacent a portion of the control knob proximate an approximate desired setting of the control knob;
wherein a second major surface of the sheet of material opposite the first major surface is capable of receiving a mark thereon to further indicate a desired setting of the control knob.

2. The marker of claim 1 further comprising an adhesive material disposed along the first major surface.

3. The marker of claim 2, said adhesive material being a non-permanent, removable adhesive.

4. The marker of claim 2 further comprising a releasable backing extending along the adhesive material opposite the first major surface.

5. The marker of claim 1, the sheet of material defining at least one preexisting indicia for indicating an approximate desired setting of the control knob.

6. The marker of claim 5, the at least one preexisting indicia being defined by a perimeter shape of the sheet of material.

7. The marker of claim 6 wherein the sheet of material defines a curved inner edge configured to extend along the control panel adjacent a portion of the control knob.

8. The marker of claim 7, the sheet of material defining a radial thickness extending radially outwardly from the curved inner edge, the preexisting indicia being defined by a portion of the sheet of material at which the radial thickness is maximized.

9. The marker of claim 8, the sheet of material defining a crescent shape.

10. The marker of claim 5, the at least one preexisting indicia being defined by one or more markings along the second major surface.

11. The marker of claim 1, the second major surface defining an erasable surface.

12. The marker of claim 11, the second major surface being a dry-erase surface.
